(19) United States
(12) Patent Application Publication
(10) Pub. No.: US 2023/0361600 A1
(43) Pub. Date: Nov. 9, 2023

(54) MULTIMODE WIRELESS CHARGING TRANSMITTER CONTROL

(71) Applicant: Cypress Semiconductor Corporation, San Jose, CA (US)

(72) Inventors: Prasanna Venkateswaran VIJAYAKUMAR, Fremont, CA (US); Jegannathan Mattapa RAMANUJAM, Bangalore (IN); Satishbabu BHOGINENI, Guntur (IN); Jhong Yang WU, New Taipei City (TW)

(73) Assignee: Cypress Semiconductor Corporation, San Jose, CA (US)

(21) Appl. No.: 18/103,547

(22) Filed: Jan. 31, 2023

(30) Foreign Application Priority Data
May 6, 2022 (IN) 202211026361

(51) Int. Cl. H02J 50/12; H02J 7/00

(52) U.S. Cl. CPC H02J 50/12; H02J 7/00712; H02J 7/00711; H02J 2207/20

(57) ABSTRACT

Systems, methods, and devices are described to improve wireless charging devices. Systems include a power inverter configured to generate a power transfer signal based, at least in part, on a plurality of transmission parameters, a transmission element configured to wirelessly transmit the power transfer signal, and a controller configured to determine a power transfer mode used by the power inverter based, at least in part, on a plurality of operational parameters and a plurality of configuration parameters.

### CROSS-REFERENCE TO RELATED APPLICATIONS

This application claims priority under 35 U.S.C. § 119(b) to Indian Patent Application No. 202211026361, filed May 6, 2022, which is incorporated by reference herein in its entirety for all purposes.

### TECHNICAL FIELD

This disclosure generally relates to wireless devices, and more specifically, to wireless charging of such wireless devices.

### BACKGROUND

Wireless devices may be configured to utilize various wireless charging components to recharge batteries and other power storage devices. Accordingly, such wireless devices may have associated charging stations, and such devices and charging stations may have transmitters and receivers including, among other things, inductive elements configured for charging operations. Moreover, wireless devices and their associated charging stations may be capable of multiple different charging modes. However, conventional wireless devices and charging stations remain limited because they are limited in their ability to efficiently implement such different modes and determine which mode should be implemented when.

### BRIEF DESCRIPTION OF THE DRAWINGS

FIG. 1 illustrates a diagram of an example of a system for wireless charging, configured in accordance with various embodiments.

FIG. 2 illustrates a diagram of another example of a system for wireless charging, configured in accordance with various embodiments.

FIG. 3 illustrates a diagram of an example of a logic device, configured in accordance with some embodiments.

FIG. 4 illustrates a diagram of another example of a logic device, configured in accordance with some embodiments.

FIG. 5 illustrates a diagram of an example of a method for wireless charging, configured in accordance with various embodiments.

FIG. 6 illustrates a diagram of another example of a method for wireless charging, configured in accordance with various embodiments.

FIG. 7 illustrates a diagram of an example of a method for duty-based control of wireless charging, configured in accordance with various embodiments.

FIG. 8 illustrates a diagram of an example of a method for voltage-based control of wireless charging, configured in accordance with various embodiments.

FIG. 9 illustrates a diagram of an example of a method for frequency-based control of wireless charging, configured in accordance with various embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless charging systems may include various components to generate signals used to transfer power between wireless elements during a power transfer phase. One or more control techniques may be used to control different aspects of such signals, such as a duty cycle. However, conventional wireless devices and charging stations remain limited because they are limited in their ability to efficiently switch between control modes, and often require additional hardware resources to generate associated signals, such as multiple pulse width modulators.

Embodiments disclosed herein provide the ability to generate control signals for inverter stages using fewer resources and fewer pulse width modulators. For example, logic devices as disclosed herein may be configured to generate multiple control signals based on a single pulse width modulator. Moreover, embodiments disclosed herein are able to dynamically (e.g., during charging operations) switch between operational modes and dynamically configured parameters used in such modes. In this way, operational modes may be intelligently selected and configured dynamically during charging operations. As will be discussed in greater detail below, such operational modes may include duty control, frequency control, and voltage control modes, and each of these modes may be selected and configured dynamically to provide efficient and seamless switching between modes when appropriate.

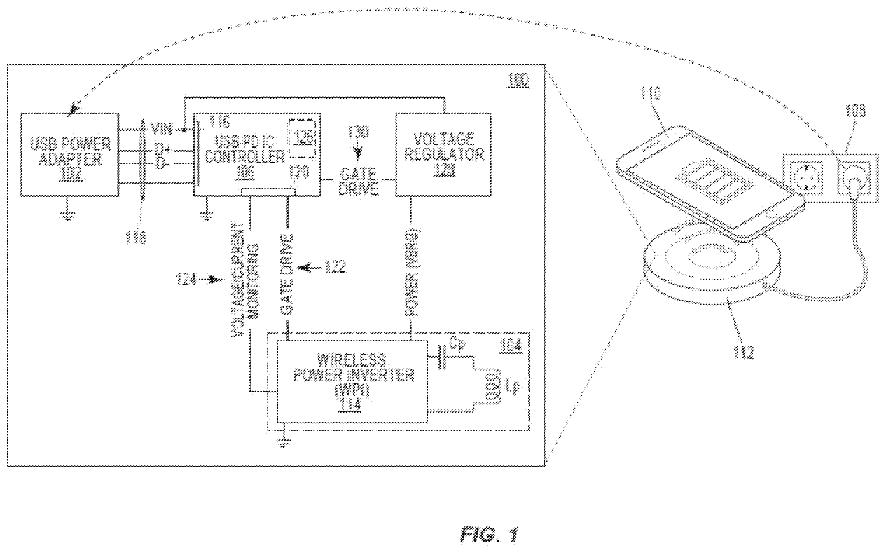

FIG. 1 illustrates a diagram of an example of a system for wireless charging, configured in accordance with various embodiments. More specifically, a system, such as wireless charging system 100, may be configured to support different operational modes for charging operations. As will be discussed in greater detail below, various components of wireless charging system 100 may include control logic that may be configured to determine transmission parameters used for wireless charging, and to determine which operational mode should be used at what time. In some embodiments, such management of different operational modes is performed using a single pulse width modulator, thus allowing implementation of such operational mode control without additional synchronization logic.

In various embodiments, wireless charging system 100 includes Universal Serial Bus (USB) power adaptor 102, wireless charging station 104, and USB-Power Delivery (PD) integrated circuit (IC) controller 106 coupled to both USB power adaptor 102 and wireless charging station 104. USB power adaptor 102 interfaces with a power source such as AC mains and outputs a voltage ‘VIN’ based on the power source. In some embodiments, USB power adaptor 102 plugs into wall outlet 108. However, other AC power source configurations are possible. USB power adaptor 102 may be compliant with the USB-PD specification, USB-C specification, PPS (Programmable Power Supply) specification, etc. In general, the voltage VIN output by USB power adaptor 102 may have relatively small output voltage steps, e.g., every 10 mV, 40 mV, 100 mV, etc., or larger steps, e.g., 5V, 12V and 15V.

Wireless charging station 104 wirelessly charges wireless charging device 110 such as a cellular phone, smartphone, PDA (personal digital assistant), PDA phone, etc. in charging proximity of wireless charging station 104. Wireless charging station 104 may be integrated in charging pad 112 and may include Wireless Power Inverter (WPI) 114 for wirelessly transferring power via magnetic induction to charge a battery included in wireless charging device 110 placed on charging pad 112. WPI 114 may be a full-bridge or halfbridge inverter having voltage ‘VBRG’ as a DC input voltage, for example.

Wireless charging station 104 includes an induction coil Lp placed in a series resonant circuit with a capacitor Cp to yield a resonant circuit with a natural resonance when coupled to the corresponding coil (not shown) included in wireless charging device 110. When wireless charging device 110 is placed on charging pad 112, the proximity of the coils allows an electromagnetic field to be created. This electromagnetic field allows power to pass from the coil Lp in charging pad 112 to the coil in wireless charging device 110. The induction coil in wireless charging device 110 uses the transferred power to charge the device battery. More than one coil may be used on the transmit and receive sides.

The same USB-PD IC controller 106 is used to control both wireless charging station 104 and USB power adaptor 102. USB-PD IC controller 106 includes first USB port 116 for coupling USB-PD IC controller 106 to USB power adaptor 102 over USB cable 118. USB-PD IC controller 106 may control USB power adaptor 102 via D+ and D− data pins on USB power adaptor 102.

USB-PD IC controller 106 also includes second port 120 for coupling the USBPD IC controller 106 to wireless charging station 104. USB-PD IC controller 106 may control wireless charging station 104 via gate drive signal 122 provided to WPI 114 of wireless charging station 104. For example, gate drive signal 122 may be a PWM (pulse width modulation) signal provided to a gate driver of WPI 114 for controlling the gates of power transistors that form full-bridge or half-bridge inverter of WPI 114. USB-PD IC controller 106 may control wireless charging station 104 based on voltage and/or current information 124 received from wireless charging station 104.

USB-PD IC controller 106 also includes logic 126 for controlling the level of the voltage VIN output by USB power adaptor 102 and the output power level of wireless charging station 104. The input voltage ‘VBRG’ of wireless charging station 104 corresponds to the voltage VIN output by USB power adaptor 102 or is derived from the voltage VIN output by USB power adaptor 102. As explained above, the USB power adaptor output voltage VIN may have relatively small voltage steps, e.g., every 10 mV, 40 mV, 100 mV, etc.

If the degree of voltage control available at USB power adaptor 102 is sufficient to implement the full output power range of wireless charging station 104, the USB power adaptor output voltage VIN may be input directly as the wireless charging station input voltage VBRG and USB-PD IC controller 106 may control the output power level of wireless charging station 104 by changing the level of VIN and/or the operating frequency or duty cycle of wireless charging station 104. If more granular voltage level control is needed to implement the full output power range of wireless charging station 104, wireless charging system 100 may also include voltage regulator 128 such as a DC/DC switching regulator such as a buck regulator or other type of step-down converter for regulating the input voltage VBRG of wireless charging station 104 based on the voltage VIN output by USB power adaptor 102. In this case, USB-PD IC controller 106 also controls voltage regulator 128, e.g., via gate drive signal 130 such as a PWM signal for controlling power transistors of voltage regulator 128.

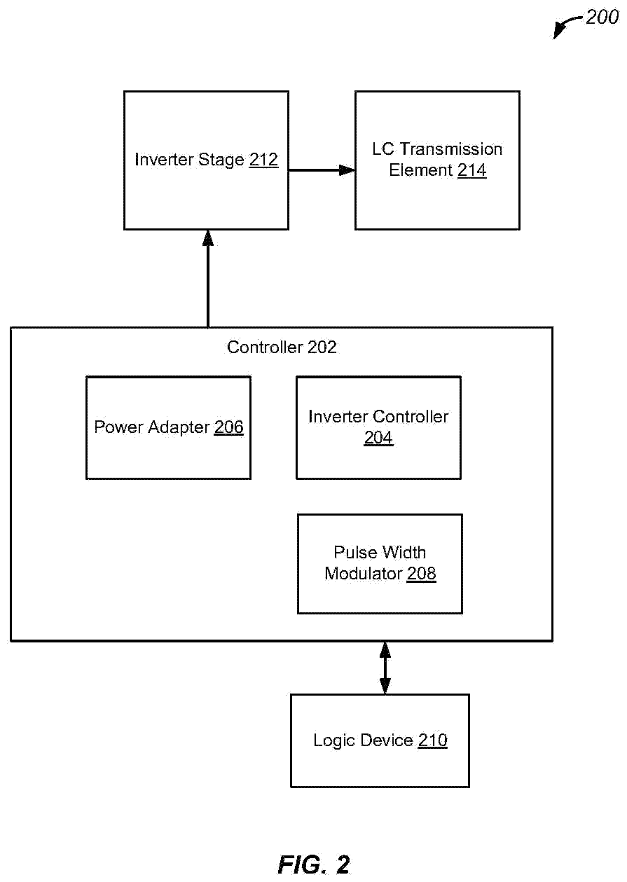

FIG. 2 illustrates a diagram of another example of a system for wireless charging, configured in accordance with various embodiments. As similarly discussed above, a system, such as wireless charging system 200, may be configured to support different operational modes for charging operations. As will be discussed in greater detail below, various components of wireless charging system 200 may include control logic that may be configured to determine transmission parameters used for wireless charging, and to determine which operational mode should be used at what time

As similarly discussed above, system 200 may include a controller, such as controller 202, which is configured to control operation of various components within system 200. More specifically, controller 202 may include components such as inverter controller 204 and pulse width modulator 208. As similarly discussed above, inverter controller 204 may be configured to control operation of an inverter stage of a power inverter, such as inverter stage 212. As will be discussed in greater detail below, inverter controller 204 may be configured to control input signals, such as input currents, provided to transistors included in inverter stage 212. Accordingly, inverter controller 204 may be configured to control the operation of one or more transistors included within inverter stage 212. In some embodiments, inverter stage 212 includes transistors configured as a halfbridge inverter. In various embodiments, inverter stage 212 includes transistors configured as a fullbridge inverter. As shown in FIG. 2, inverter stage 212 may be coupled to a transmission element, such as LC transmission element 214, which is configured to transmit an output signal for wireless charging.

System 200 further includes pulse width modulator 208 which is configured to generate a control signal used to drive power transfer operations. Accordingly, a control signal generated by pulse width modulator 208 may have a designated frequency, amplitude, and duty cycle. Thus, pulse width modulator 208 may be configured to generate a control signal that is ultimately used to drive other system components, such as inverter stage 212 and LC transmission element 214. However, as will be discussed in greater detail below, one or more other components, such as logic device 210, may generate additional signals based on an output of pulse width modulator 208, and such additional signals may also be used for these purposes.

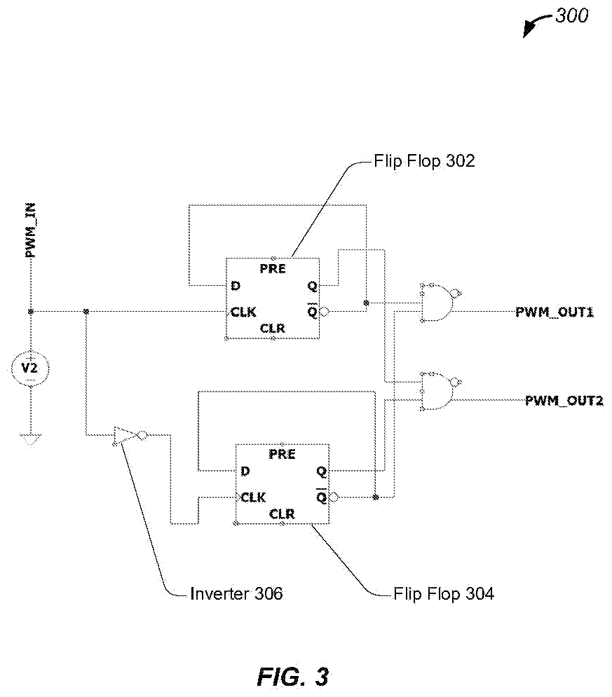

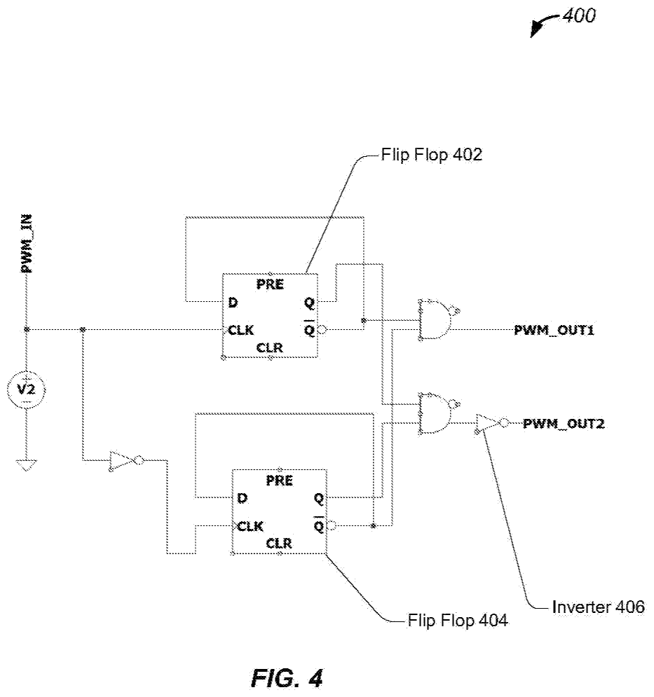

System 200 additionally includes logic device 210 which is configured to receive a signal from pulse width modulator 208, and generate one or more output signals based on the received signal. As will be discussed in greater detail below with reference to FIG. 3 and FIG. 4, logic device 210 is configured to generate multiple output signals based on a single signal received from a single pulse width modulator. Accordingly, multiple outputs may be generated by logic device 210, and may be provided to components of controller 202, such as inverter controller 204 to control components of inverter stage 212, such as one or more transistors.

System 200 may also include power adapter 206 which is configured to receive power from a power source. Accordingly, power adapter 206 may include a power sink and low-dropout (LDO) regulator configured to receive power via a cable, such as a USB cable, and provide power to other components of controller 202.

FIG. 3 illustrates a diagram of an example of a logic device, configured in accordance with some embodiments. As discussed above, a logic device, such as logic device 300, may be configured to generate output signals used to control one or more components of a transmitter, such as an inverter stage, during a duty control operational mode of operation. In some embodiments, two outputs are generated using a single pulse width modulator. Accordingly, as will be discussed in greater detail below, multiple control signals associated with a duty control operational mode may be generated for a transmitter using a single pulse width modulator. In this way, additional pulse width modulators are not needed, and overall hardware resources used are reduced.

In various embodiments, logic device 300 receives an input from a pulse width modulator that may be included in a controller, as discussed above. The input signal received from the pulse width modulator may be provided as a clock (CLK) signal for flip flops, such as first flip flop 302 and second flip flop 304. As shown in FIG. 3, the input provided to second flip flop 304 may first be provided to inverter 306. In some embodiments, a Q output of a flip flop asserts HIGH at a low to high transition of a CLK signal. Moreover, an inverted Q output of a flip flop may introduce a delay in the output. In this way, an inverted output of a flip flop is delayed, and the delay may be configured to correspond to, and be similar to an ON time and/or an OFF time, and thus equivalent to a dead time associated with ON/OFF and OFF/ON transitions.

As shown in FIG. 3, each of flip flop 302 and flip flop 304 may have Q outputs and inverted Q outputs with delays. As also shown in FIG. 3, the outputs are ANDed with their complimentary Q outputs from their corresponding flip flops. The resulting outputs are two equal width pulses with a half period start delay. One output is provided to a high side field effect transistor (FET) of a half bridge included in an input stage of a transmitter, and the other output is provided to a low side (FET) of the half bridge. In this way, diagonal pairs of FETs are provided with the same pulse to achieve full bridge duty control in an inverter stage of a power inverter.

FIG. 4 illustrates a diagram of another example of a logic device, configured in accordance with some embodiments. As discussed above, a logic device, such as logic device 400, may include flip flops, such as flip flop 402 and flip flop 404, that are configured to generate output signals used to control one or more components of a transmitter, such as FETs included in an inverter stage, during a duty control operational mode of operation. In some embodiments, two outputs are generated using a single input from a single pulse width modulator. Accordingly, as will be discussed in greater detail below, multiple control signals associated with a duty control operational mode may be generated for a transmitter using a single pulse width modulator. As will also be discussed in greater detail below, logic device 400 may be in communication with a controller, as discussed above with reference to FIGS. 1 and 2, and such controller may have a buck boost controller in which buck voltage and boost voltages are configurable and may be set via SetBuck and SetBoost signals.

More specifically, SetBuck and SetBoost signals may be used to provide override capabilities that are configured to provide an additional delay with programmable gate control. In one example, such additional delay may be provided via inverter 406. In some embodiments, the additional delay is introduced to ensure that two bottom FETs in the bridge of the input stage are kept in an ON state, thus avoiding floating voltages. As shown in FIG. 4, inverter 406 is configured to generate the SetBoost signal, and the output labelled PWM_out1 is configured as the SetBuck signal. In various embodiments, avoiding the floating voltages results in improved duty control because currents in the inverter stage are less distorted regardless of duty. In various embodiments, less distortion in the currents results in less harmonic induced conduction losses in a coil of the transmitter. At lower duty cycles, the discontinuity in phase voltage waveforms is may be interference source. Moreover, floating voltages in a primary coil winding may also be a source of noise of in-band communication. Accordingly, reducing distortion and noise in these components may result in improved duty control performance and transmission performance.

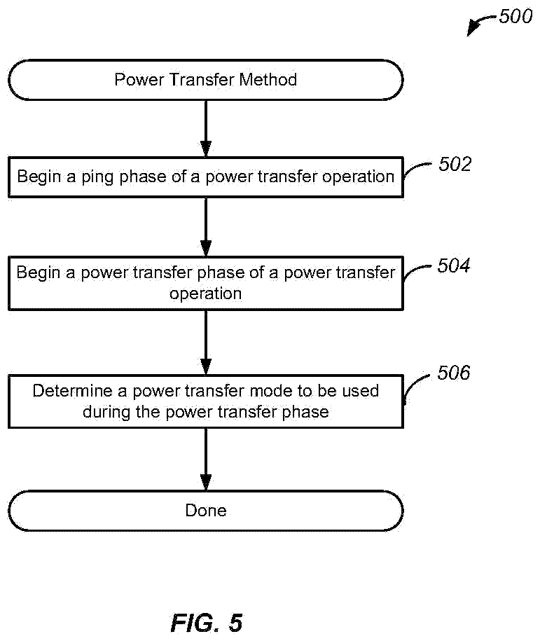

FIG. 5 illustrates a diagram of an example of a method for wireless charging, configured in accordance with various embodiments. As will be discussed in greater detail below, a method, such as method 500, may be performed to provide multi-mode control for wireless charging. More specifically, method 500 may provide control over transmission parameters, such as voltage level control, frequency control, phase control, and duty cycle control. In this way, control logic may efficiently manage a mode of operation of the wireless charging, and its underlying transmission parameters, depending on one or more operational parameters.

Method 500 may perform operation 502 during which a ping phase may be started. Accordingly, a ping signal may be sent from a transmitter to determine if a receiver is present. Thus, during operation 502, a transmitter may send a ping signal, and may receive a response from a receiver if the receiver is nearby when, for example, docked at a charging station.

Method 500 may perform operation 504 during which a power transfer phase may be started. Accordingly, in response to identifying the presence of the receiver, the transmitter may switch to a power transfer phase in which it generates a signal configured to transfer power to one or more components of the receiver in accordance with one or more transmission parameters. Accordingly, during operation 504, the transmitter may switch from the ping phase to the power transfer phase.

Method 500 may perform operation 506 during which a transfer mode may be determined. Accordingly, as will be discussed in greater detail below, the transmitter may determine various transmission parameters that control aspects of the of the power charging signal, such as voltage level, frequency, phase, and duty cycle. More specifically, the transmitter may select a particular power transfer mode to be used during at least a portion of the power transfer phase. As will also be discussed in greater detail below, the transmitter may be configured to provide intelligent and efficient selection of such power transfer modes as well as switching between modes to improve an efficiency of the implementation of the power transfer.

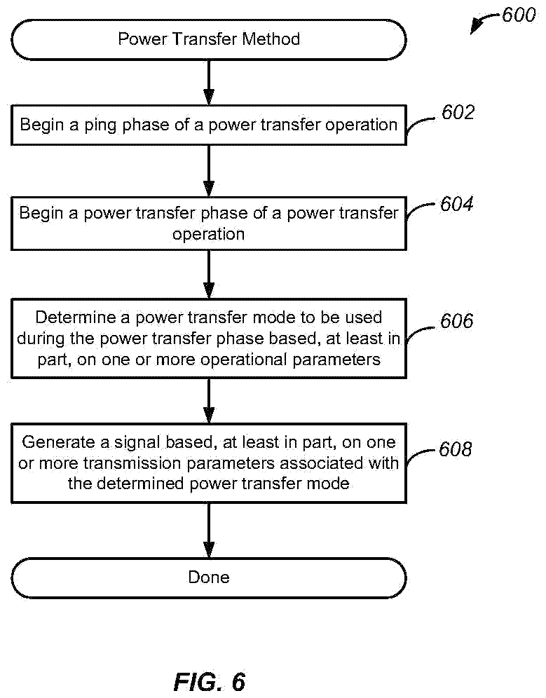

FIG. 6 illustrates a diagram of another example of a method for wireless charging, configured in accordance with various embodiments. As similarly discussed above, a method, such as method 600, may be performed to provide multi-mode control for wireless charging. More specifically, method 600 may provide control over various transmission parameters. As will be discussed in greater detail below, the transfer power phase may be configured to provide intelligent and dynamic management of charging modes that are used by transmitters and receivers. In this way, the charging mode may be selected and adjusted to improve overall efficiency of charging operations.

Method 600 may perform operation 602 during which a ping phase may be started. As similarly discussed above, a ping signal may be sent from a transmitter to determine if a receiver is present. Thus, during operation 602, a transmitter may send a ping signal, and may receive a response from a receiver if the receiver is nearby when, for example, docked at a charging station.

Method 600 may perform operation 604 during which a power transfer phase may be started. Accordingly, in response to identifying the presence of the receiver, the transmitter may switch to a power transfer phase in which it generates a signal configured to transfer power to one or more components of the receiver in accordance with one or more transmission parameters. Accordingly, during operation 604, the transmitter may switch from the ping phase to the power transfer phase.

Method 600 may perform operation 606 during which a power transfer mode may be determined. In various embodiments, the power transfer mode may be determined based on one or more operational parameters of the receiver and/or transmitter, such as a load, frequency, and coupling factor as well as other configuration parameters of the receiver and transmitter. As will be discussed in greater detail below, configuration parameters may include parameters such as duty cycle parameters, voltage parameters, frequency parameters, and/or mode change values. In some embodiments, such operational parameters may be mapped to a power transfer mode based on a designated mapping that may be stored in memory. Such a designated mapping may have been previously generated by an entity, such as a manufacturer. In one example, the designated mapping may be a look-up-table configured to return a power transfer mode based on one or more operational parameters. As will be discussed in greater detail below, the designated mapping may also store data values to map power transfer modes to transmission parameters configured to implement each power transfer mode. In one example, such a mapping may have been determined by an entity, such as a manufacturer, using one or more simulation tools. Accordingly, the operational parameters and configuration parameters may be used to select a particular power transfer mode based on a designated mapping. In this way, a power transfer mode may be dynamically selected based on current operational parameters of the receiver and/or transmitter.

In some embodiments, operational parameters may include a current load associated with a power inverter and its associated transmission element. For example, if transmission element is under no load or light load, a power transfer mode may be set to duty control, and the duty cycle may change from 50% to 20%. Otherwise, if there is a load, the power transfer mode may be set to voltage control, and a voltage may be changed from 5V to 12V. If the voltage reaches a designated threshold value, such as 12V and there are one or more other operational parameters such as a control error, the power transfer mode may be changed to a frequency control mode, and will thus provide more power to a receiver. When in frequency control mode, the frequency can change from 141 KHz to 110 KHz. If a receiver is configured to support a high power protocol, the power transfer mode may be set to a voltage control mode that supports a higher voltage range, such as 12V to 20V. In this example, the power transfer mode may be changed to frequency control mode if a voltage of 20V is reached. In this way, changes in operational parameters may be detected and used to trigger a change in a power transfer mode to ensure that an efficient power transfer mode is continually and dynamically selected.

Method 600 may perform operation 608 during which a signal may be generated by the transmitter based, at least in part, on the transmission parameters. Accordingly, the determined power transfer mode may be mapped to various transmission parameters based on a designated mapping, and the transmitter may generate a signal based on the transmission parameters. The signal may be received by the receiver, and used to charge one or more components of the wireless device associated with the receiver.

It will be appreciated that, method 600 may be repeated as appropriate in response to the initiation of a new charging cycle or operation. Accordingly, the power transfer mode may be dynamically updated in response to changes in operational parameters of the receiver and/or transmitter, or one or more other changes.

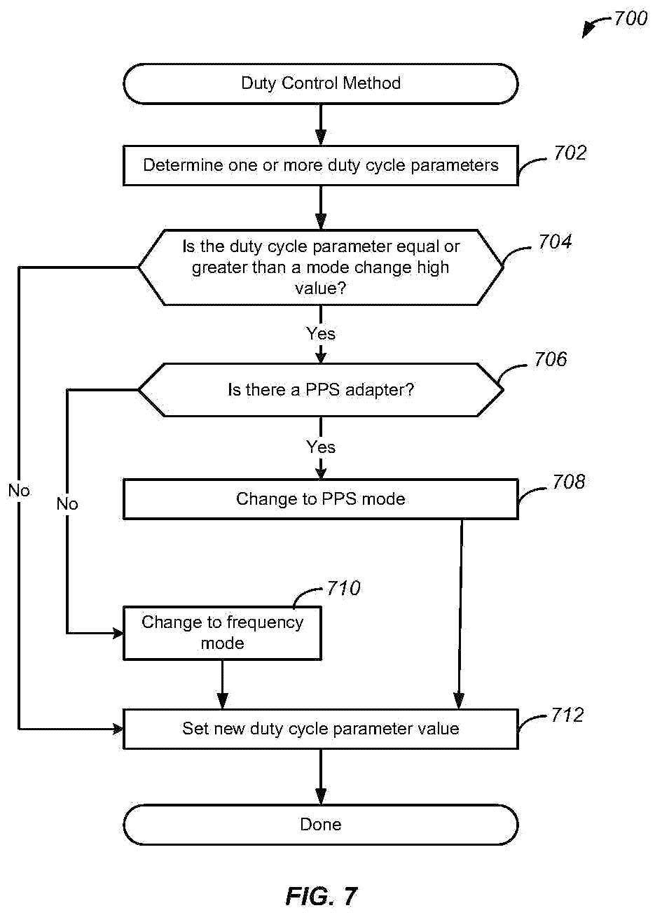

FIG. 7 illustrates a diagram of an example of a method for duty-based control of wireless charging, configured in accordance with various embodiments. As discussed above, one or more operational modes may be selected. As will be discussed in greater detail below, a method, such as method 700 may be performed to determine if a duty control operational mode should be used, and also whether or not one of more duty cycle parameters should be updated or set. In this way, duty control operational modes may be utilized and configured dynamically.

Method 700 may perform operation 702 during which one or more operational mode parameters may be determined. As similarly discussed above, a ping phase may have been started. In some embodiments, the ping phase may operate at 141 KHz and a 5V PPS input. Subsequently a configuration and negotiation phase may be performed in which proportional-integral-derivative (PID) parameters may be determined. For example, it may be determined whether or not extended power profile (EPP) or baseline power profile (BPP) PID parameters should be used based on one or more designated parameters. In various embodiments, PID parameters are determined for a given mode (such as BPP or EPP) based on a previously performed simulation or mathematical modelling of a given power transmitter design. Such a simulation may have been performed by an entity, such as a manufacturer, during a design process, and may be performed using a simulation tool, such as PSpice® or any other suitable simulation tool. These parameters are stored in a storage location as a look up table. Thus, for a determined mode, initial PID parameters may be retrieved via a result returned by the look up table.

Subsequently, a power transfer phase may be started to transfer power once a device has been detected. In various embodiments, during initiation of the power transfer phase, one or more operational mode parameters may be determined to identify an initial mode of operation to be used for power transfer. Accordingly, a coil current value associated with an LC transmission element may be obtained, and a PID error may be calculated based on the current value.

Accordingly, during operation 702, operational mode parameters may be retrieved if they have been previously stored to determine a current operational mode. Such an operational mode parameter may be stored in memory, and may have been determined in a previous iteration of methods disclosed herein. If no operational mode parameter is stored, a default value may be selected, as may be set by an entity, such as a manufacturer. In some embodiments, a default mode of duty control operational mode may be selected. As will be discussed in more detail below, one or more additional operations may be performed to determine if an operational mode should be switched, and if a different operational mode should be selected. In one example, it may be determined if an operational mode of duty control operational mode should be selected, and if one or more parameters of the duty control operational mode should be modified or updated.

Method 700 may perform operation 704 during which it may be determined if the one or more duty cycle parameters are equal to or greater than a mode change high variable. In some embodiments, a mode change high (MCH) value may be a designated threshold value configured to determine when a duty control mode is exited or switched away from. For example, the MCH value may be a threshold duty cycle value of 50%. Moreover, the one or more duty cycle parameters may be determined based on duty cycle adjustment parameter and one or more clamp voltages. For example, a duty cycle parameter labeled Duty_old may be a current or existing duty cycle parameter. In some embodiments, a set point error correction may be computed using any suitable mathematical computation to determine a duty adjustment parameter that may be labeled duty_adjust. In various embodiments, clamp voltage MAX/MIN duty ratios may have been previously determined by an entity, such as a manufacturer, during a simulation and design process to avoid control system oscillations. If it is determined that the one or more duty cycle parameters are less than the MCH value, then method 700 may proceed to operation 712 during which a new duty cycle parameter value may be set. In various embodiments, the new duty cycle parameter may be determined by adding the old duty cycle with the duty adjustment parameter. In another example, the new duty cycle parameter may be set to a clamp MAX. If it is determined that the one or more duty cycle parameters are equal to or greater than the MCH value, then method 700 may proceed to operation 706.

Accordingly, during operation 706 it may be determined if there is a programable power supply (PPS) adapter. Such a determination may be made based on known hardware capabilities of a wireless charging device. Accordingly, if it is determined that a PPS adapter is not present and available, method 700 may proceed to operation 710 during which an operational mode may be set to a frequency mode, as will be discussed in greater detail below. If it is determined that a PPS adapter is present, method 700 may proceed to operation 708.

Accordingly, method 700 may perform operation 708 during which a mode may be changed to a PPS mode. In various embodiments, a PPS mode is configured to use a programmable power supply input to the inverter bridge. Once set to PPS mode, method 700 may proceed to operation 712. As discussed above, during operation 712, a new duty cycle parameter value may be set. In one example, PPS mode is entered by exiting duty cycle control mode, and setting the new duty cycle parameter to a clamp MAX duty value.

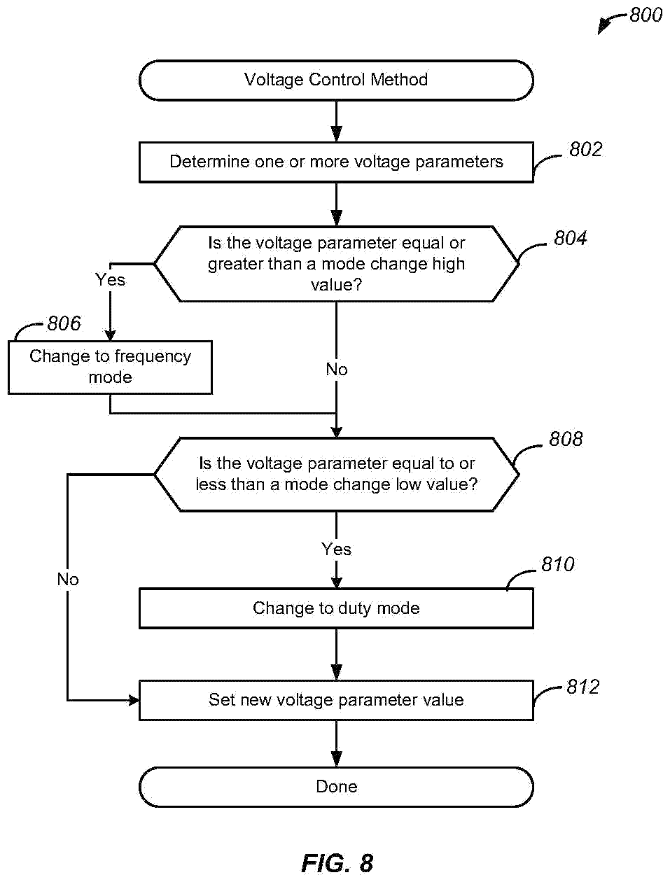

FIG. 8 illustrates a diagram of an example of a method for voltage-based control of wireless charging, configured in accordance with various embodiments. As discussed above, one or more operational modes may be selected. As will be discussed in greater detail below, a method, such as method 800 may be performed to determine if a voltage control operational mode should be used, and also whether or not one of more voltage parameters should be updated or set. In this way, voltage control operational modes may be utilized and configured dynamically.

Method 800 may perform operation 802 during which one or more voltage parameters may be determined. As similarly discussed above, an initial mode of operation may have been determined. If the initial mode of operation is a voltage mode, one or more voltage parameters may be determined. For example, a voltage parameter labeled VBUS_old may be determined based on an existing or operating voltage. In some embodiments, a set point error correction value may be determined using any suitable mathematical computation, and may be used to compute a voltage parameter labeled V_adjust.

Method 800 may perform operation 804 during which it may be determined if the one or more voltage parameters are equal to or greater than a mode change high value. In some embodiments, a mode change high value may be a designated threshold value. For example, the mode change high value may be 21V. As similarly discussed above, a mode change high value may be configured to determine when a voltage control mode is exited, and when a frequency control mode is entered. In some embodiments, the mode change high value is computed based on coil electrical parameters and system capability parameters that may be determined by an entity, such as a manufacturer, during a design and simulation process. If it is determined that the one or more voltage parameters are greater than or equal to a mode change high value, method 800 may perform operation 806, and an operational mode may be changed to a frequency control operational mode.

If it is determined that the one or more voltage parameters are less than a mode change high value, method 800 may perform operation 808, during which it may be determined whether or not the one or more voltage parameters are equal to or less than a mode change low value. For example, the mode change low value may be 5V. In various embodiments, a mode change low value may be configured to determine when a voltage control mode is exited, and a duty control mode is entered. As similarly discussed above, the mode change low value may be computed based on coil electrical parameters and system capability parameters that may be determined by an entity, such as a manufacturer, during a design and simulation process. Accordingly, if it is determined that the one or more voltage parameters are equal to or less than a mode change low value, method 800 may perform operation 810 in which an operational mode may be changed to a duty control operational mode. If it is determined that the one or more voltage parameters are greater than a mode change low value, method 800 may perform operation 812 during which a new voltage parameter value may be set. In one example, the new voltage parameter may be a new PPS voltage sent to a PPS adapter. In some embodiments, the new PPS voltage may be determined by adding VBUS_old and V_adjust. In various embodiments, the PPS voltage may be set to a clamped MAX/MIN VBUS value.

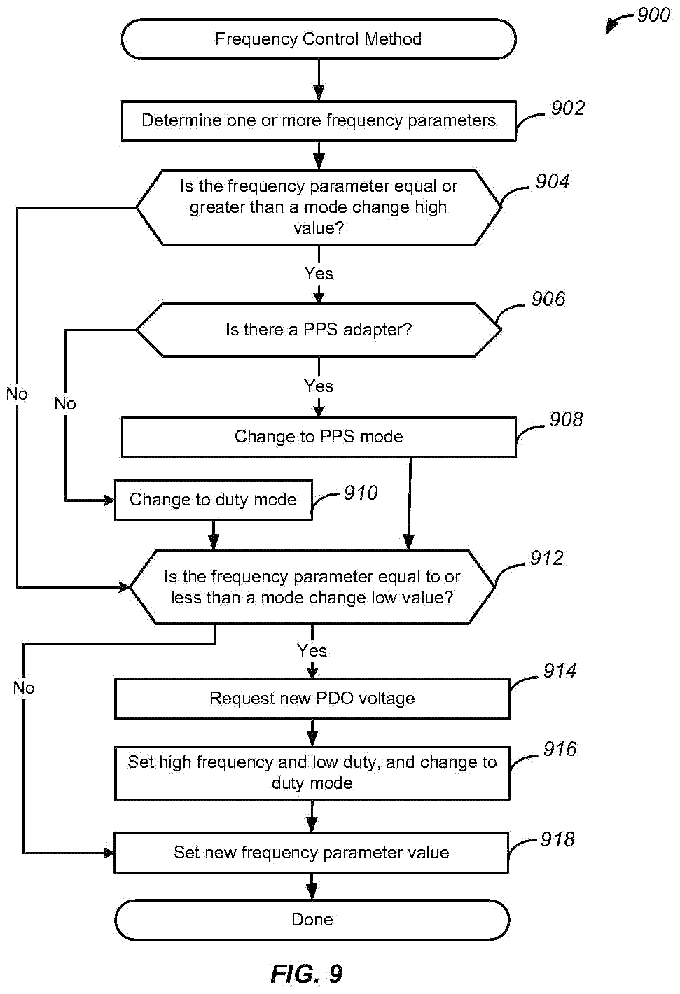

FIG. 9 illustrates a diagram of an example of a method for frequency-based control of wireless charging, configured in accordance with various embodiments. As discussed above, one or more operational modes may be selected. As will be discussed in greater detail below, a method, such as method 900 may be performed to determine if a frequency control operational mode should be used, and also whether or not one of more frequency parameters should be updated or set. In this way, frequency control operational modes may be utilized and configured dynamically.

Method 900 may perform operation 902 during which one or more frequency parameters may be determined. As similarly discussed above, an initial mode of operation may have been determined. If the initial mode of operation is a frequency mode, one or more frequency parameters may be determined. For example, a frequency parameter labeled Freq_old may be determined based on an existing or operating frequency. In some embodiments, a set point error correction value may be determined using any suitable mathematical computation, and may be used to compute a frequency parameter labeled Freq_adjust.

Method 900 may perform operation 904 during which it may be determined if the one or more frequency parameters are equal to or greater than a mode change high value. In some embodiments, a mode change high value may be a designated threshold value. For example, the mode change high value may be 141 KHz. A mode change high value may be configured to determine when a frequency control mode is exited, and when a duty control mode is entered. In some embodiments, the mode change high value is computed based on an electromagnetic emission standard. If it is determined that the one or more frequency parameters are greater than or equal to a mode change high value, method 900 may perform operation 906, during which it may be determined if a PPS adapter is present.

As discussed above, it may be determined if a PPS adapter is present based on known hardware capabilities of a wireless charging device. Accordingly, if it is determined that a PPS adapter is present, method 900 may perform operation 908, and an operational mode may be changed to a PPS operational mode. If it is determined that a PPS adapter is not present, an operational mode may be changed to a duty control operational mode.

Returning to operation 904, if it is determined that the one or more frequency parameters are less than a mode change high value, method 900 may perform operation 912, during which it may be determined if the one or more frequency parameters are equal to or less than a mode change low value. For example, the mode change low value may be 110 KHz. In various embodiments, a mode change low value may be configured to determine when a frequency control mode is exited, and a voltage control mode is entered. As similarly discussed above, the mode change low value may be computed based on coil electrical parameters and a system gain parameter that may be determined by an entity, such as a manufacturer, during a design and simulation process to avoid over voltages on a receiver and transmitter. If it is determined that the one or more frequency parameters are equal to or less than a mode change low value, method 900 may perform operation 914, during which a new power delivery object (PDO) voltage may be requested from a PDO adapter.

Method 900 may perform operation 916 during which a high frequency and a low duty cycle may be selected, and an operational mode may be changed to a duty control operational mode. In various embodiments, the high frequency may be determined based on the mode change high value for the frequency control mode, and the low duty cycle may be determined based on the mode change low value for the duty control mode.

Returning to operation 912, if it is determined that the one or more frequency parameters are greater than a mode change low value, method 900 may perform operation 918, during which a new frequency parameter value may be set. In some embodiments, the new frequency parameter may be determined by addint Freq_old and Freq_adjust. In various embodiments, the new frequency parameter may be set to one or more clamped MAX/MIN frequency values.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A system for wireless charging, the system comprising:
a power inverter configured to generate a power transfer signal based, at least in part, on a plurality of transmission parameters;
a transmission element configured to wirelessly transmit the power transfer signal; and
a controller configured to determine a power transfer mode used by the power inverter based, at least in part, on a plurality of operational parameters and a plurality of configuration parameters.

2. The system of claim 1, wherein the determining of the power transfer mode further comprises determining the plurality of transmission parameters.

3. The system of claim 2, wherein the plurality of transmission parameters represents at least one of a voltage level, a frequency, a phase, and a duty cycle.

4. The system of claim 1, wherein the power transfer mode is determined based, at least in part, on a designated mapping.

5. The system of claim 4, wherein the designated mapping is a look-up-table configured to return a power transfer mode based on one or more operational parameters.

6. The system of claim 1, wherein the controller is configured to control an inverter stage included in the power inverter.

7. The system of claim 6, wherein the power inverter is a single-stage inverter.

8. The system of claim 1, wherein the controller is further configured to:
change the power transfer mode in response to identifying one or more changes in the plurality of operational parameters.

9. The system of claim 8, wherein the one or more changes in operational parameters comprises a change in load associated with the transmission element.

10. A method for wireless charging, the method comprising:
determining, using a processing device, a power transfer mode used by a power inverter based, at least in part, on a plurality of operational parameters and a plurality of configuration parameters;
generating, using a power inverter, a power transfer signal based, at least in part, on a plurality of transmission parameters; and
transmitting, using a transmission element, the power transfer signal.

11. The method of claim 10, wherein the determining of the power transfer mode further comprises:
determining the plurality of transmission parameters.

12. The method of claim 11, wherein the plurality of transmission parameters represents at least one of a voltage level, a frequency, a phase, and a duty cycle.

13. The method of claim 10, wherein the power transfer mode is determined based, at least in part, on a designated mapping.

14. The method of claim 13, wherein the designated mapping is a look-up-table configured to return a power transfer mode based on one or more operational parameters.

15. The method of claim 10 further comprising:
changing the power transfer mode in response to identifying one or more changes in operational parameters.

16. A device for wireless charging, the device comprising:
a controller comprising processing elements to determine a power transfer mode used by a power inverter based, at least in part, on a plurality of operational parameters and a plurality of configuration parameters; and
duty control logic comprising processing elements configured to generate at least one control signal for the power inverter based on the determined power transfer mode.

17. The device of claim 16, wherein the determining of the power transfer mode further comprises determining a plurality of transmission parameters representing at least one of a voltage level, a frequency, a phase, and a duty cycle.

18. The device of claim 16, wherein the power transfer mode is determined based, at least in part, on a designated mapping, and wherein the designated mapping is a look-up-table configured to return a power transfer mode based on one or more operational parameters.

19. The device of claim 16, wherein the controller comprises a pulse width modulator.

20. The device of claim 16, wherein the controller is further configured to:
change the power transfer mode in response to identifying one or more changes in operational parameters.
